(19) United States
(12) Patent Application Publication
(10) Pub. No.: US 2013/0194843 A1
(43) Pub. Date: Aug. 1, 2013

(54) AC/DC LOW VOLTAGE POWER SUPPLY DEVICE AND METHOD OF STEPPING DOWN AC/DC VOLTAGE

(71) Applicant: Eran Ofek, Modiin (IL)

(72) Inventor: Eran Ofek, Modiin (IL)

(73) Assignee: NEY-LI PTE. LTD., Singapore (SG)

(21) Appl. No.: 13/812,069

(22) PCT Filed: Jul. 26, 2011
(86) PCT No.: PCT/IL11/00601

§ 371 Date: Apr. 5, 2013

Related U.S. Application Data
(60) Provisional application No. 61/367,456, filed on Jul. 26, 2010.

(51) Int. Cl. H02M 7/04

(52) U.S. Cl. CPC H02M 7/04
USPC 363/84

(57) ABSTRACT

An alternating current/direct current (AC/DC) power supply device includes a stepping down unit for stepping down voltage provided by an electric power source, wherein the power source provides a voltage up to but not exceeding a predetermined value. The stepping down unit includes a switch for connecting or disconnecting an energy storage device or a load device to an AC electrical source.

### FIELD OF THE INVENTION

The present application relates to an AC/DC low voltage power supply device, and, more specifically, to a voltage converter based on sampling input voltage amplitude.

### BACKGROUND

Power converters are becoming a hot topic with ever increasing electronic devices that require clean DC power. Industry today is aiming at providing AC-DC adapters with small form factors for portable applications like notebook chargers, phone chargers, and the like. The power densities of devices are improving constantly. The improvement in technology and availability of more power efficient devices has led to a tremendous improvement in AC-DC conversion efficiency and size of the converters.

A typical method for performing AC to DC conversion uses linear converters. Linear converters step down the voltage using a transformer and regulate the output voltage with a regulator. This architecture may suffer from low efficiency. Additionally, the necessary size of a transformer for systems operating at a line frequency of 50 Hz-60 Hz is too large for portable applications.

A second typical method for performing AC to DC conversion uses switch mode power supplies. Switch mode power supplies, have found a huge market because of their small form factor and high efficiency which make them suitable for portable applications. However, switched mode power supplies have undesirable non-linear characteristics that may introduce harmonics and power factor problems.

### SUMMARY OF THE INVENTION

An alternating current/direct current (AC/DC) power supply device is disclosed. The device includes a stepping down unit for stepping down voltage provided by an electric power source up to a predetermined value. The stepping down unit includes a switch for connecting or disconnecting an energy storage device or a load device to an AC electrical source.

### BRIEF DESCRIPTION OF THE DRAWINGS

FIG. 1 is a graphical representation of input AC voltage and sampled pulses;

FIG. 2 is an example schematic diagram of AC-DC conversion;

FIG. 3 is a schematic diagram of an example power supply;

FIG. 4 is a graphical representation of the measured waveforms of rectified and output voltages;

FIG. 5 is a graphical representation of dependence of device efficiency on output thereof; and

FIG. 6 is a graphical representation of sampled pulses and capacitor voltage.

### DETAILED DESCRIPTION OF THE INVENTION

In order to meet various international regulations and standards, a two stage architecture may be required, such as a power factor correction (PFC) stage followed by a DC-DC stage. This approach, while being successful, increases the complexity of the system due to the two control loops. A two stage approach mostly uses a boost PFC circuit for the first stage, due to good PFC capability and high efficiency provided by this circuit. The consequence of using it in the first stage, however, is the high voltage output which requires a capacitor with high voltage rating resulting in increase in size and cost.

A single stage architecture combines the PFC and DC-DC stage into a single stage, reducing the control complexity. The PFC correction can also be done without a bridge rectifier. Additionally, a single stage approach provides a less complex solution resulting in size reduction.

Another single stage converter application may utilize PFC in DCM mode to obtain PFC correction and may obtain a regulated output DC voltage using a fly back converter controlled by a single switch. This type of converter may include a two transistor clamped fly back converter integrated with a boost PFC as a single stage converter.

The architectures discussed above use a boost PFC, require a good quality boost inductor, an additional inductor or transformer, and a bridge rectifier which increases the size. They require good rectifiers with high heat dissipation capability, high current capability and low loss. The conduction loss of rectifiers and the forward voltage drop of the diodes limit the achievable efficiency. Hence to tackle these and to reduce the number of switching devices in the current path and thereby increase the efficiency many bridgeless PFC architectures have been proposed.

Using a bridgeless SEPIC converter is an easy way to step up or step down the voltage while eliminating the need for a high voltage capacitor in the first stage. Also by adopting a bridgeless scheme the number of components that switch in a cycle is reduced greatly resulting in improved efficiency. The SEPIC converter operates in DCM mode and achieves a good PFC. Also, the SEPIC converter does not need an isolated drive to control MOSFET devices, reducing the number of required components. An exemplary 100 watt (W) converter may operate at an efficiency of more than 89% with a power factor of 0.9 at high loads.

It is noted that a requirement of input inductors that operate at low frequency which necessitates a large size. Also, the output capacitor must be large to suppress ripple voltage. For a 50 Hz AC supply, the circuit also suffers a 100 Hz ripple at the output. Since SEPIC is a higher order converter, the control loop must be designed with care to avoid instability.

The architectures above aim to achieve high efficiency while lowering the first stage voltage, thereby reducing the component sizes in successive stages. A disadvantage of the architectures may be an increased size due to the use of more inductors.

An additional architecture may include a rectifier, a switching device, and an output capacitor. The architecture rectifies and chops an input AC wave with a switch. The switch connects the input to the capacitor only when the input voltage is lower than a required voltage thereby limiting the voltage swing seen by the first stage capacitor and allowing the capacitor to have a lower voltage rating and size. This architecture may not provide electrical isolation and may generate harmonic distortion of current. Since the input is directly chopped, the current harmonics may be high and may require additional filtering to meet harmonic standards.

The power of electric current is defined by the following equation:

P=IU, Equation (1)

where I is a current across a load and U is a voltage applied to the load.

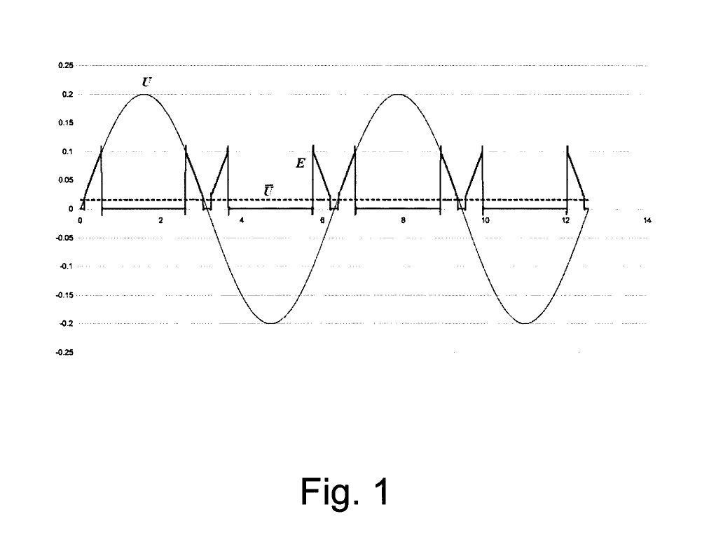

In the case of varying voltage and current, the average power P̅ is given by

$$\overline{P} = \frac{1}{N} {\sum }_{i = 0}^{N - 1} {u}_{n} {i}_{n} , \qquad Equation ( 2 )$$

where uₙ and iₙ are instantaneous values of the voltage and current, respectively. The values uₙ and iₙ are measured with a predetermined measurement pitch. The analogous values are digitalized by an analog-digital converter and multiplied together to obtain the average power P̅. Reference is now made to FIG. 1, presenting graphs of main voltage U. A sampling element of an AC/DC low voltage power supply device is configured for connecting the load device to an electrical power source when a voltage therein is in a predetermined range and disconnecting said load device from the electrical power source when said voltage is out-of-range. In other words, the voltage is applied to the load when the voltage in the power source is within the predetermined range. The voltage may be applied to the load only when the voltage in the power source is within the predetermined range and the voltage may be disconnected from the load when the voltage is outside of the predetermined range. Thus, at the output, the AC/DC low voltage power supply device provides a train of energetic impulses E of a predetermined amplitude. The impulses can be used for charging any accumulating element or device such as a capacitor or an accumulator cell.

A goal of the current technical solution is to achieve a small form-factor and efficient transformerless AC-DC conversion over a wide DC output voltage range from 1.5V to 48V with a maximum power rating of 100 W. Additionally, a front-end harmonics filter may be desirable to reduce EMC/EMI effects due to the choppy nature of switching a portion of the AC source to the load.

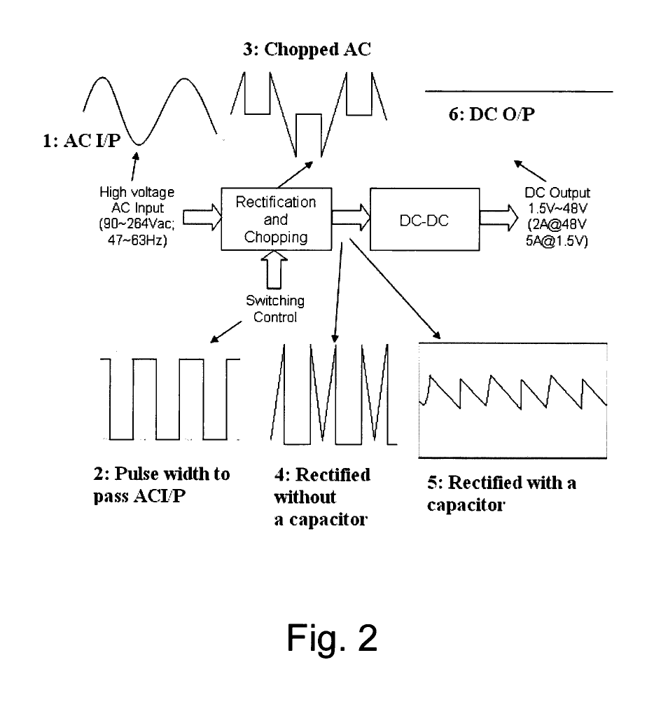

FIG. 2 is an example transformerless AC-DC converter. The exemplary converter monitors the high voltage AC input and passes only a low voltage portion of a complete AC voltage waveform to the DC-DC converter to generate a stable DC supply source. A controller will continuously monitor the AC input, which could occasionally have a phase shift due to switching on/off of transformers in a power grid, and the controller will control a switch through a pulsed signal (as shown in FIG. 2 by “Pulse width to pass AC I/P”) to pass only the lower voltage portion of an AC signal (as indicated in FIG. 2 by “Chopped AC”). An internal rectifier will then rectify this chopped AC signal to a positive-only rectified chopped AC signal (as indicated in FIG. 2 by “Rectified without Capacitor”). It may be noted that the rectification function may be bypassed to avoid any loss involved in the process when the output voltage is set to a low value and the negative portion of the AC waveform doesn't need to be passed to the DC-DC stage. A large capacitor may be used at the output to filter out the large voltage ripples to generate an output with greatly reduced voltage ripples (as indicated in FIG. 2 by “Rectified with Capacitor”) to the DC-DC converter. The DC-DC converter, (e.g., a buck converter), may further regulate the input with ripples to provide a stable DC output (as indicated in FIG. 2 by “DC O/P”).

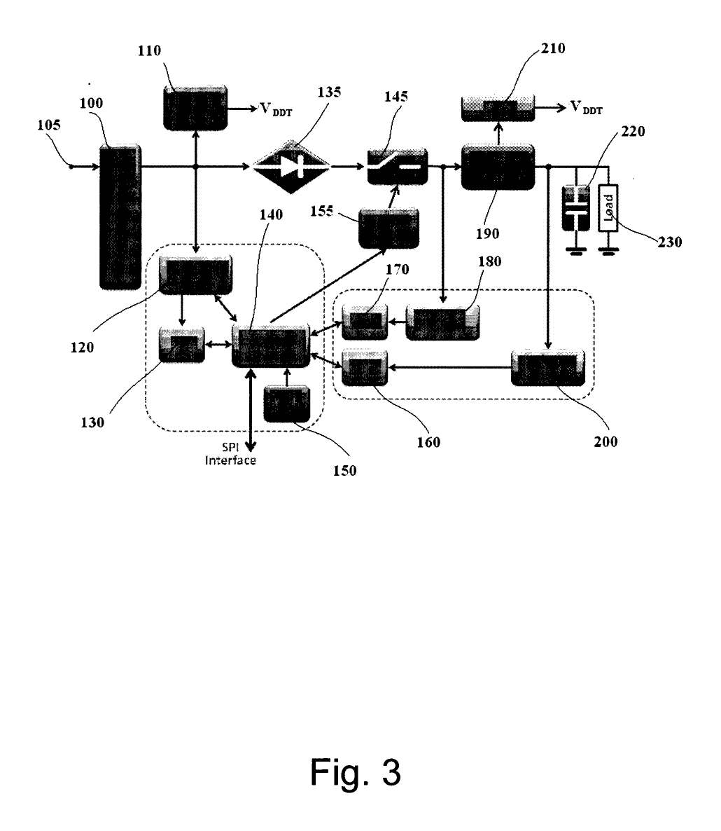

FIG. 3 is a system block diagram of an example transformerless AC-DC converter. At the input 105, some off-chip over voltage/current protection components 100 may be incorporated into the system for safety reasons. The convertor may have a built-in supply block 110 (full-wave rectifier) to provide supply voltage V_{DDT} to power up the sampling network 120 and digital controller 140 during the initial phase when the system is plugged into a power plug. The sampling network 120 and digital controller 140 may then continuously monitor the AC input for information such as an input frequency, zero crossing, and an input amplitude. A full wave rectifier 135 may rectify the input voltage. A switch 145 may be driven by a gate driver 155 which may be controlled by the controller 140. Voltages, which may be sampled by the switch 145 and provided by a DC-DC converter 190, may be sensed by voltage sensors 180 and 200, respectfully. Data from the sensors 180 and 200 may be gathered by the controller 140. Analog-digital conversion may be performed by ADCs 130, 160 and 170. A DC-DC converter 190 and a low dropout regulator 210 may convert a rippled input voltage such that a steady output voltage is generated which is lower than the minimum of the input. The voltage provided by the DC-DC converter 190 may charge a capacitor 220. The capacitor 220 may be discharged across a load 230.

A highly efficient and well-regulated supply can be obtained by using a buck converter in the second stage of conversion. The controller for switching may be implemented on FPGA.

Except for the MOSFET switches, the capacitor, and the single buck inductor, all other components of the convertor may be integrated on a chip. By implementing a digital controller, a highly programmable and highly efficient converter can be achieved. Because the buck converter can achieve close to 95% efficiency, the chopping stage may determine the overall efficiency. Simulation results of the above first stage using LT spice was performed for two different MOSFET models, one with an rds on (“on resistance”) of 30 milliohms (mil) and another MOSFET with an rds on of 300 mΩ.

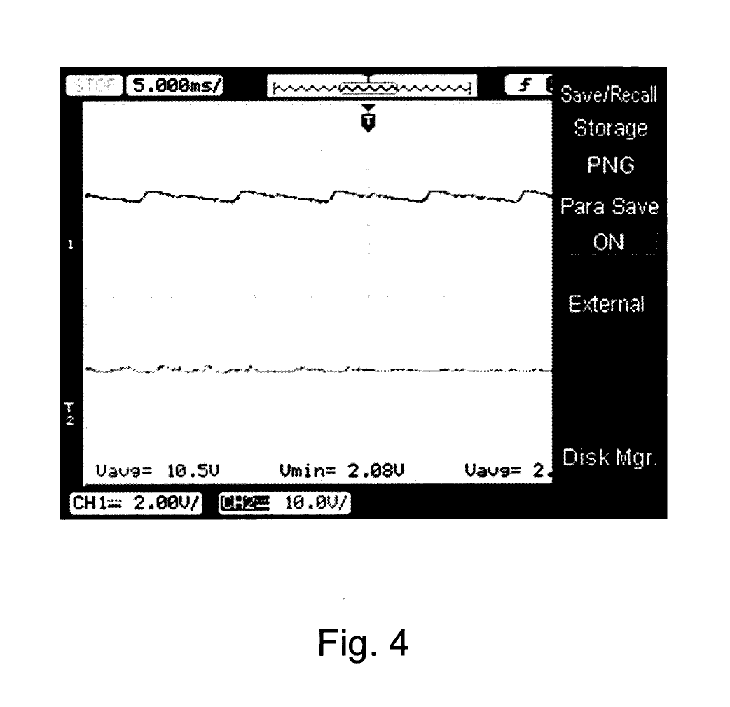

FIG. 4 shows experimental curves of waveforms obtained at the first stage output with 10× attenuation (upper curve) and at the dc-dc output (lower curve).

The DC-DC output has been set to 10 volts and the first stage minimum voltage was set at more than 20 volts. A clean DC signal of 10.5 volts with very low ripple at the output was obtained.

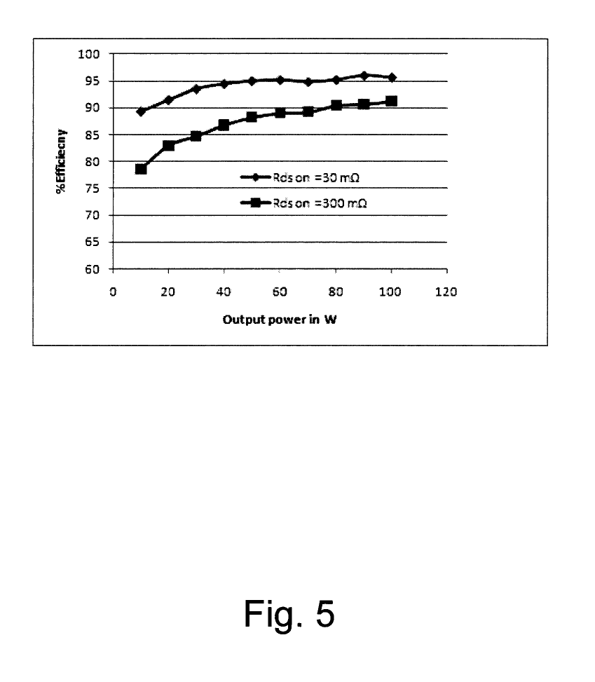

FIG. 5 shows a graph of the efficiency of the first stage with respect to output power for two different values of MOSFET “on resistance”. A MOSFET of 30 mΩ “on resistance” provides an efficiency of more than 89% for most load conditions. FIG. 5 clearly shows the drop in efficiency with an increase in MOSFET “on resistance”. A MOSFET with a low “on resistance” may be chosen for the first stage to minimize switching losses. Also, the rectifier might be chosen to minimize losses. An EMI filter may be used in concert to attenuate harmonic currents resulting from chopping the input. Also, in applications where isolation is primary concern, a fly back dc-dc converter may be used in the second stage to provide transformer isolation instead of a simple buck converter.

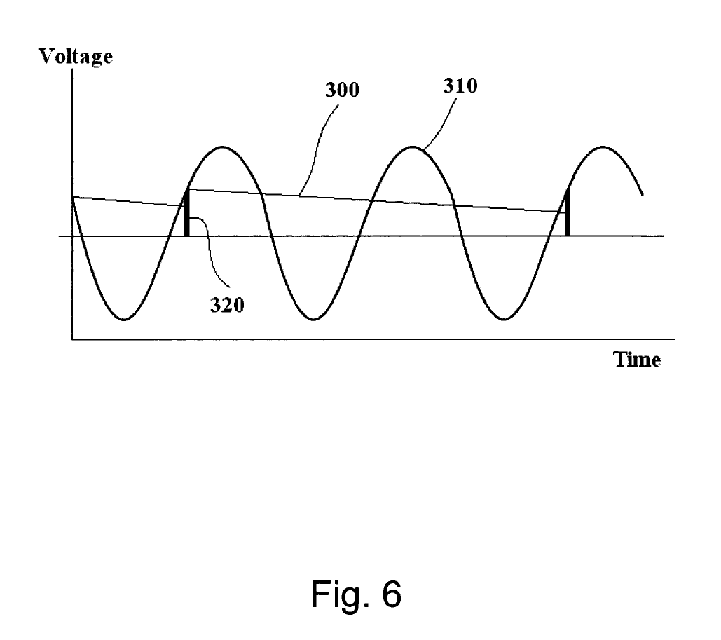

FIG. 6 depicts various waveforms associated with the exemplary system depicted in FIG. 3. Input AC voltage 310 is sampled when the AC voltage achieves a predetermined value. Obtained pulses 320 charge the capacitor 220 of the device of FIG. 3. The controller 140 is preprogrammed to keep a voltage 300 at the capacitor substantially constant. In one embodiment, the controller 140 may actuate the switch 145 when the voltage 300 is below a predetermined value (for example, 1.5, 6, 9, 12 , 24 V or any other voltage appropriate for the particular implementation). The converter may automatically drop into a standby state when there is no energy consumption by the load and provide the predetermined voltage to the load as needed.

The power supply described above can be used for energizing a low voltage load such as an LED light, a telephone, a PDA, a camera, a computer, a rechargeable device, or any other suitable low voltage device. It may be noted that the power supply described above may provide minimal (about 5%) losses.

### Embodiments

1. An alternating current/direct current (AC/DC) low voltage power supply device connectable to a load.

2. The device of embodiment 1, further comprising a stepping down unit for stepping down voltage provided by an electric power source up to a predetermined value.

3. A device as in any preceding embodiment, wherein a stepping down unit comprises a switch configured for connecting an energy storage device or a load device to an AC electrical source at a phase of a period of the AC sinusoid when the AC voltage is in a predetermined range.

4. A device as in any preceding embodiment wherein a stepping down unit comprises a switch configured for disconnecting an energy storage device or load device from an AC electrical source when a voltage is out-of-range.

5. A device as in any preceding embodiment wherein a switch is configured to be in a standby position when a voltage at an energy storage device is equal or higher than a predetermined value.

6. A device as in any preceding embodiment wherein a switch is configured to be actuated when said voltage is lower that than a predetermined value.

7. A device as in any preceding embodiment further comprising a controller configured for controlling a switch such that said switch is open when a voltage at said energy storage device is equal or higher than a predetermined value.

8. A device as in any preceding embodiment further comprising a controller configured for controlling a switch such that said switch is closed when said voltage is lower than said predetermined value.

9. A device as in any preceding embodiment further comprising at least one sensor configured for measuring at least one voltage selected from the group consisting of an input AC voltage, a rectified voltage and an output voltage.

10. A device as in any preceding embodiment further comprising a unit for rectifying sampled voltage pulses.

11. A device as in any preceding embodiment further comprising a pulse skipping modulated buck converter.

12. A device as in any preceding embodiment wherein an energy storage device is selected from the group consisting of an accumulator cell, a capacitor and/or any combination thereof.

13. A device as in any preceding embodiment wherein a power supply device is implemented in and for energizing a low voltage appliance.

14. A device as in any preceding embodiment wherein a low voltage home appliance is selected from the group consisting of a telephone, PDA, camera, computer, a rechargeable device, and/or any combination thereof.

15. A device as in any preceding embodiment wherein voltage sampling includes at least one parameter selected from the group consisting of a sampling phase, a sampled voltage, a setting error thereof and/or any combination thereof.

16. A device as in any preceding embodiment further comprising a control unit adapted to control a predetermined voltage range responsively to energy storage and/or supply parameters.

17. A method of providing a low voltage to a load in accordance with any preceding embodiment.

1. A power supply device connectable to a load, comprising:
a stepping down unit configured for stepping down voltage from an electric power source to a first predetermined voltage value, wherein the stepping down unit comprises a switch, wherein the switch is configured for connecting the load to the electrical power source at a phase of a period of the electrical power source on a condition that a sampled voltage of the electric power source is in a determined range, and wherein the switch is configured for disconnecting the load from the electrical power source on a condition that the sampled voltage is outside the determined range or a stored energy in an energy storage device is equal to or greater than a second predetermined voltage value.

2. The power supply device according to claim 1, further comprising a controller configured for controlling the switch wherein the switch is open on a condition that the voltage at the energy storage device is equal or higher than the second determined voltage value and is closed on a condition that the voltage is lower than the second determined voltage value.

3. The power supply device according to claim 1, further comprising at least one sensor configured for measuring at least one voltage selected from the group consisting of an input AC voltage, an input DC voltage, a rectified voltage, and an output voltage.

4. The power supply device according to claim 1, further comprising a unit for rectifying the sampled voltage.

5. The power supply device according to claim 1, further comprising a pulse skipping modulated buck converter.

6. The power supply device according to claim 1 wherein the energy storage device is selected from the group consisting of an accumulator cell, a capacitor, and any combination thereof.

7. The power supply device according to claim 1, wherein the power supply device is implemented in a low voltage appliance and is configured for energizing the low voltage appliance.

8. The power supply device according to claim 7, wherein the low voltage appliance is selected from the group consisting of a telephone, PDA, camera, computer, a rechargeable device, and any combination thereof.

9. The power supply device according to claim 1, wherein the sampled voltage includes at least one parameter selected from the group consisting of a sampling phase, a sampled voltage, a setting error thereof and any combination thereof.

10. The power supply device according to claim 1, further comprising a control unit to control the determined range responsively to energy storage and supply parameters.

11. A method of providing a voltage to a load, comprising:
receiving voltage from an electric power source;
stepping down the voltage from the electric power source to a first predetermined voltage value;
connecting a load to the electrical power source at a phase of a period of the electric power source on a condition that a sampled voltage of the electric power source is in a determined range; and
disconnecting the load from the electrical power source on a condition that sampled voltage is outside the determined range or a stored energy in an energy storage device is equal to or greater than a second predetermined voltage value.

12. The method according to claim 11, further comprising controlling a switch, wherein the switch is open to disconnect the load from the electric power source on a condition that the voltage at the energy storage device is equal or higher than the second determined voltage value and is closed to connect the load to the electric power source on a condition that the voltage is lower that the second determined voltage value.

13. The method according to claim 11, further comprising measuring at least one voltage selected from the group consisting of an input AC voltage, an input DC voltage, a rectified voltage, and an output voltage.

14. The method according to claim 11, further comprising rectifying the sampled voltage.

15. The method according to claim 11, further comprising utilizing a pulse skipping modulated buck converter.

16. The method according to claim 11 wherein the energy storage device is selected from the group consisting of an accumulator cell, capacitor, and any combination thereof.

17. The method according to claim 11, further comprising energizing a low voltage appliance.

18. The method according to claim 17, wherein the low voltage appliance is selected from the group consisting of a telephone, PDA, a rechargeable device, and any combination thereof.

19. The method according to claim 11, wherein the sampled voltage includes at least one parameter selected from the group consisting of a sampling phase, a sampled voltage, a setting error thereof, and any combination thereof.

20. The method according to claim 11, further comprising utilizing a control unit to control the determined range responsively to energy storage and supply parameters.

21-36. (canceled)
